(19) United States
(12) Patent Application Publication
(10) Pub. No.: US 2005/0266254 A1
(43) Pub. Date: Dec. 1, 2005

(54) Plastic injection molding with gas assisted metal moldings therein

(75) Inventor: Harvinder Singh, Shelby Township, MI (US)

Correspondence Address: VISTEON, C/O BRINKS HOFER GILSON & LIONE, PO BOX 10395, CHICAGO, IL, 60610, US

(73) Assignee: Visteon Global Technologies, Inc.

(21) Appl. No.: 11/192,699

(22) Filed: Jul. 29, 2005

Related U.S. Application Data
(62) Division of application No. 10/183,905, filed on Jun. 25, 2002.

(51) Int. Cl. B22D 19/02; B32B 15/04

(52) U.S. Cl. 428/457; 164/98; 164/113

(57) ABSTRACT

The present invention details the construction of a plastic injection molded part having a molded metal reinforcement located therein. Additionally, provided by the invention is a method for manufacturing such a molded part and an apparatus for performing that method.

### BACKGROUND OF THE INVENTION

1. Field of the Invention

The present invention relates to plastic injection molding. More specifically, the present invention relates to plastic injection molding where gas assisted molding is further supplemented by metal molding to form a plastic injection molded part having molded metal reinforcement located therein.

2. Description of Related Art

Numerous thin walled plastic products are provided in today's economy as injection molded parts. The mechanical strength of the thin walled plastic products can at best be said to be marginal. In order to provide additional strength in these parts, a prior practice of injection molders has been to add external ribs to the part design. While these ribs provide some added mechanical strength to the part, in many situations, they are structurally insufficient. Additionally, the inclusion of these ribs and the additional material going into their formation, can result in structural and surface defects which compromise the aesthetic acceptability and structural integrity of the part. One such defect is warping at the part and another is “sink marks”. Sink marks are a result of large thicknesses of material that contract upon solidification such that a depression or recess forms in the surface of the region adjacent to the thick section. Sink marks are not typically acceptable from either a structural standpoint or an aesthetic standpoint.

One way to eliminate and/or reduce the formation of sink marks is through the use of gas assisted injection molding.

With gas assisted injection molding, once the mold cavity has been substantially or completely injected with plastic material, pressurized gas is introduced into the plastic material already in the mold cavity. As a result of the introduction of this pressurized gas, the previously injected plastic material is forced outward in all directions and into complete conformity with the surfaces defining the cavity. Because the outermost portion of the molten plastic freezes upon contact with the surfaces defining the cavity, the gas tends to be retained in an interior portion of the plastic.

While warping and sink marks are eliminated with gas assisted injection molding, there still remains a degree of aesthetic imperfection.

More importantly, the introduction of the gas pocket itself reduces the structural integrity of the injection molded part. Specifically, a gas pocket forms within plastic body of the injection molded part.

### SUMMARY OF THE INVENTION

In view of the drawbacks and limitations of the known technologies, the present invention has as its primary object the formation of plastic injection molded parts where surface defects, such as warping and sink marks, are eliminated (or significantly reduced) while the structural integrity and strength of the part remains high, higher than similarly shaped gas assisted injection molded parts.

In achieving the above, the present invention provides an injection molded plastic part formed with a body of a predetermined external shape. The body is formed of injection molded plastic material. Molded within the plastic body is a metal reinforcement that enhances the structural integrity and strength of the molded part.

In providing the molded plastic part mentioned above, the present invention provides a method of molding a structurally enhanced plastic part utilizing the steps of: providing a mold having a cavity defining the shape of the part to be molded; injecting plastic material into the mold to at least partially fill the cavity of the mold; introducing liquid metal into the interior of the plastic material previously injected into the mold cavity; solidifying the plastic material; solidifying the metal material; and removing the molded part from the mold.

Additionally, the present invention can further include the step of forming a pocket within the plastic material before the introduction of liquid metal into the plastic material. The formation of the pocket may be achieved by injecting a pressurized gas into the plastic material.

In another aspect, the present invention details an apparatus for molding plastic parts having gas assisted metal moldings therein. The apparatus as such includes a mold with interior surfaces defining a cavity of predetermined shape. A first injector assembly is coupled to the mold and includes components for injecting plastic resin into the mold cavity. A second injector assembly is similarly coupled to the mold and includes components for injecting a liquid metal into the plastic material. Additionally, a controller is coupled to the first and second injectors and coordinates the sequencing of the operation of the injectors, as well as the closing of the mold halves, the opening of the mold halves, and the removal of the molded part therefrom.

The apparatus can also include a gas injection assembly. The gas injection assembly uses a source of pressurized gas and associated components for injecting gas into the plastic material after the plastic material has been introduced into the mold cavity, but before molding of the metal.

Other objects and advantages of the present invention will become apparent to those skilled in the technology to which the invention relates, upon a review of the detailed description, and drawings taken in conjunction with the appended claims.

### BRIEF DESCRIPTION OF THE DRAWINGS

FIG. 1 is a schematic representation of the product design as intended, and further showing the inclusion of ribs in that design;

FIG. 2 is a schematic illustration of the product design as actually molded and including, opposite the ribs, sink marks in the surface of the molded part;

FIG. 3 is a schematic representation of a product formed by gas assisted injection molding;

FIG. 4 is a schematic representation of a product manufactured according to the principles of the present invention;

FIG. 5 is a schematic illustration of the manufacturing steps utilized in forming the part seen in FIG. 4;

FIG. 6 is a schematic representation of another version of a part embodying the principles of the present invention;

FIG. 7 depicts a machine utilized in practicing the method of FIG. 4 mentioned above.

### DETAILED DESCRIPTION OF THE INVENTION

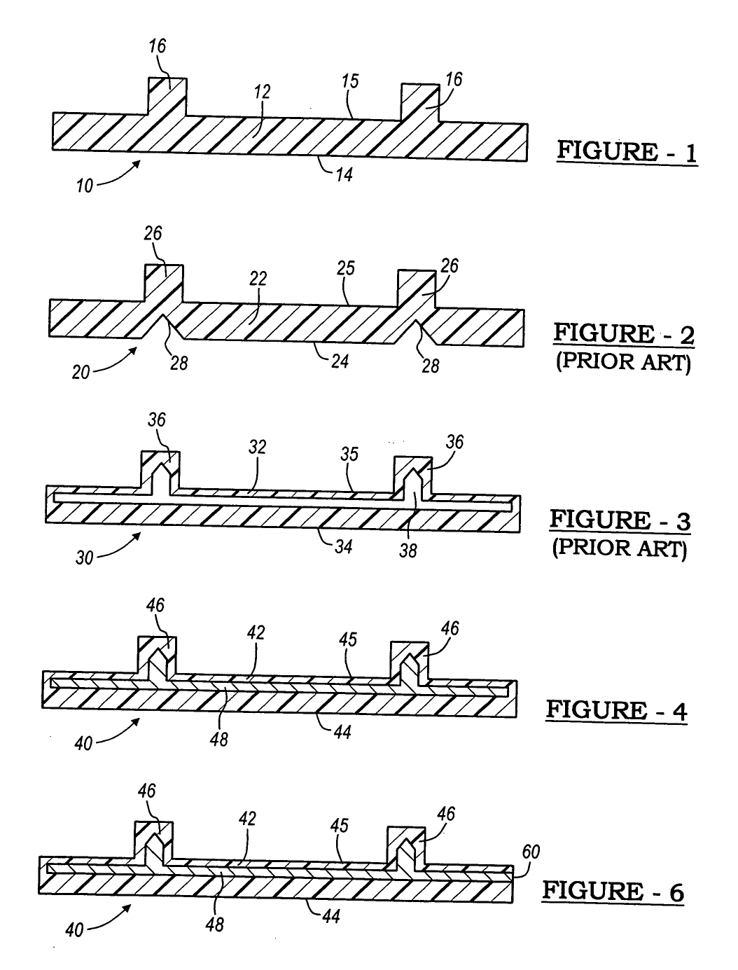

Referring now to FIG. 1, generally illustrated therein is a cross-sectional view of an injection molded part 10. The part 10 is illustrated in its “as intended” final shape. However, and as will be noted from the discussion which follows, the actual shape of such a part may include one or more defects rendering it useless.

The part 10 is an injection molding of plastic and includes a body 12 that defines front surface 14 and a rear surface 15. In order to increase the structural integrity of the part 10, a pair of ribs 16 are formed so as to extend outwardly off of the rear surface of the body 12. In its final use, the front surface 14 of the intended part 10 is desired to have a smooth, flat or other finish, free of unintended surface defects. When actually injection molded, various surface defects appear on the “as molded” part.

An “as molded” part is generally illustrated in FIG. 2 and designated at 20. Like the intended part 10, the “as molded” part 20 includes a body 22 that defines an exterior surface 24 and which includes, extending from a rear surface 25, a pair of ribs 26.

During molding of the “as molded” part 20, a predetermined amount of suitable plastic material is injected into the mold cavity so as to completely fill the mold cavity. Upon subsequent cooling of the “as molded” part 20, the material in the larger volume areas of the part 20 tend to experience collapse or shrinking. This shrinking appears as surface defects know as “shrink marks” and designated at 28. In FIG. 2, the shrink marks 28 are located generally opposite of and relative to the ribs 26. In the illustrated and merely representative part shape, the ribs 26 provide the increased thickness or material volume that results in the formation of the shrink marks 28.

In order to prevent the formation of shrink marks 28, gas assisted injection molding has been used. With gas assisted injection molding, the mold cavity is substantially filled with a plastic material that is suitable for injection molding. Once the mold cavity has been substantially or completely filled with the plastic material, or at a point in time while the mold cavity is still being filled with plastic material, a pressurized gas is injected into the interior or central portion of the plastic material. Preferably, the pressurized gas is an inert gas such as nitrogen. As a result of the center of the plastic material not being solidified immediately upon injection into the mold cavity, the injected gas forms a pressurized gas pocket within the molded part. After the pressurized gas has been turned off, a small additional amount of plastic material may be injected into the mold cavity to completely encapsulate the gas pocket.

An injection molded part manufactured via a gas assisted injection molding process is generally illustrated in FIG. 3 and designated at 30. Here, the part 30 includes a body 32 that defines a front surface 34 and a rear surface 35. Extending off of the rear surface 35 are a pair of ribs 36. Located internally of the body 32, and extending partially into the ribs 36, is a gas pocket 38.

Inclusion of the gas pocket results in the formation of a part 30 whose exterior shape substantially coincides with that of the intended part (see intended part 10 of FIG. 1). Noticeably, the shrink marks 28 of the “as molded” part 20 are prevented from forming in the gas assisted molded part 30. Unfortunately, by replacing material in the molded part 30 with a gas pocket 38, the structural integrity and strength of the part 30 is less than that which would be ideally achieved in the part of FIG. 1.

Referring now to FIG. 4, an injection molded part according to the principles of the present invention overcomes the decrease in strength caused by gas assisted injection molding and is generally illustrated and designated at 40. The part 40 includes a body 42 defining a front surface 44 and a rear surface 45. Extending outwardly off of the rear surface 45 are spaced apart ribs 46. Disposed within the body 42 is a molded reinforcement 48 of metal or metallic alloy. As seen in FIG. 4, the reinforcement 48 is completely encapsulated by the previously injection molded plastic material. Portions of the reinforcement 48 may also extend up and into the ribs 46.

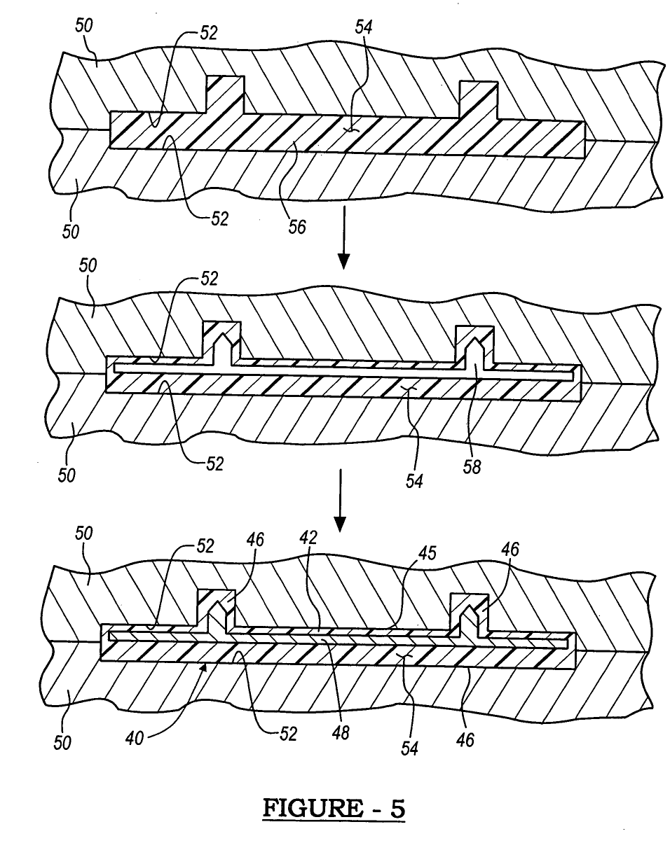

In forming the part 40 seen in FIG. 4, the methodology presented in FIG. 5 is generally followed. First, a pair of mold halves 50 are provided that include interior surfaces 52, which define a cavity 54 in the external shape of the desired part. Next, a predetermined amount of molten plastic material 56 is injected into the cavity 54 so as to substantially or completely fill the cavity 54.

At this time it is noted that the specific shape of the part seen in FIG. 5, as well as in the other figures, is merely presented for illustrated representative purposes. The actual part shape will clearly depend on specific design criteria and the intended purpose of the part. Those details are obviously beyond the scope of the present application which deals with the basic structure and manufacturing of the part.

Once the cavity 54 has been substantially or completely filled with the plastic material 56, a pressurized gas is introduced into the plastic material 56. The introduction of the gas into the interior of the plastic material 56 force the plastic material 56 into substantial conformity with the shape defined by the cavity 54 and results in the gas forming a gas pocket 58 generally centrally within the plastic resin 56. The gas pocket 58 is formed in the interior of the plastic material 56 as a result of the plastic material 56 adjacent to the interior surfaces 52 of the mold halves 50 freezing upon contact with those interior surfaces 52. Once the injection of gas is complete, and while the plastic material 56 is still cooling within the mold halves 50, liquid metal or metallic alloy (hereafter just “metal”) is injected into the gas pocket 58. The metal displaces the gas and cools, along with the plastic material 56 to form the molded part 40 having an integral metal reinforcement 48.

If desired, after completion of the injection of the liquid metal into the gas pocket 58, an additional amount of plastic material 56 may be injected into the cavity 54 to completely encapsulate the resultant reinforcement 48 within the plastic material 56. However, it is noted that the molding procedure may be varied such that the resultant reinforcement 48 is not completely encapsulated by the plastic resin 56 and such that a portion of the reinforcement 48 is externally exposed in the body 42 of the part 40. FIG. 6 illustrates a part 40, substantially the same as that seen in FIG. 4, whereas one end of the reinforcement 48 is externally exposed in the body 42 of the part 40. Since the part 40 illustrated in FIG. 6 only differs from the part 40 illustrated in FIG. 4 in that the reinforcement 48 is externally exposed, designated at 60, like reference elements are used to identify the same components of part 40 in FIG. 6 as in FIG. 4.

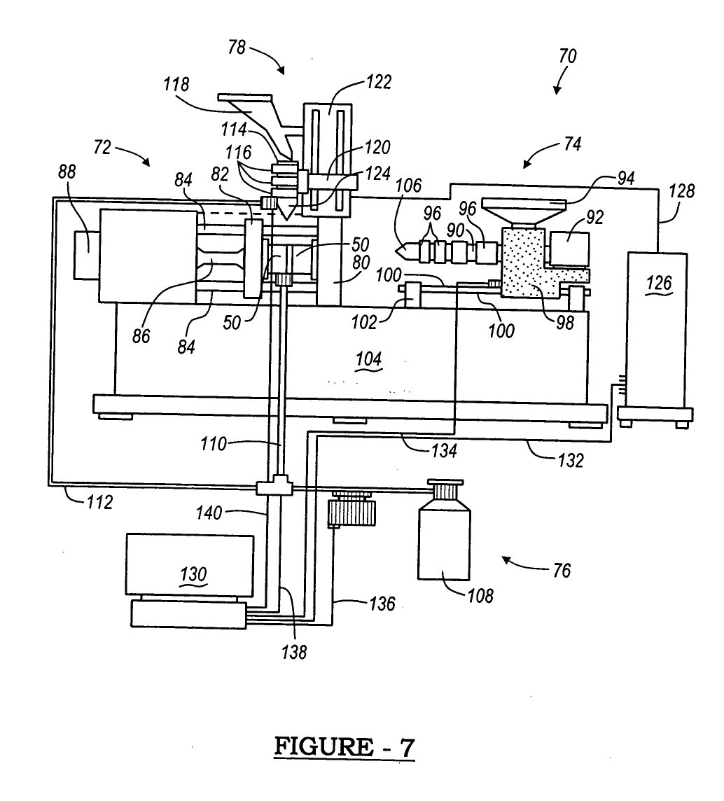

Referring now to FIG. 7, a machine 70 for performing the method and molding parts according to the principles of the present invention is illustrated therein. The machine 70 includes as its principal components a mold assembly 72, a first injector assembly 74, a gas injection assembly 76 and a second injector assembly 78.

The mold assembly 72 includes the mold halves 50 mentioned previously, one of which is mounted to a stationary platen 80 and the other of which is mounted to a movable platen 82. The movable platen 82 is supported and axially movable along guide rods 84 and coupled via a ram 86 to an actuator 88. The actuator 88 is preferably hydraulically actuated, but may alternatively be a pneumatic actuator or a mechanical actuator. Via the actuator 88 the ram 86, the platens 80 and 82 and the mold halves 50 can be moved between open and closed positions. In FIG. 7, the molds are illustrated in a closed position. When moved to the open position, the left mold half 52 moves along the guide rods 84.

The first injector assembly 74 includes common components to enable the injection of plastic material into the mold 52. These components may include a reciprocating screw located within a barrel 90 and driven by an actuator 92. The source of plastic resin fed into the first injector 74 may be provided via a feed hopper 94 coupled to the interior passageway of the barrel 90. Within the barrel 90, the plastic resin may be heated as a result of heaters 96 positioned about the barrel itself. The above-mentioned components of the first injector assembly 74 are supported by an injector frame 98, which in turn rides upon guide rods 100 mounted via supports 102 to a machine frame 104. A stepper motor or other actuator is provided within the injector frame 98 and is coupled to the guide rods 100 so as to advance the first injector 74 from a retracted position, seen in FIG. 7, to an engaged position. In the engaged position, a nozzle 106 is matingly engaged through the platen 80 and with the mold half 50 associated therewith. When engaged and when an appropriate amount of plastic material 56 has been processed within the first injector assembly 74, the predetermined amount of plastic material 56 is discharged from the first injector assembly 74 into the cavity 54 defined by the mold halves 50.

The gas injection assembly 76 includes a pressurized gas source 108 and associated valves 109 which may alternatively be coupled via lines 110 and/or 112 to either mold halves 50 or to the second injector assembly 78. Alternately, one of the lines 110 or 112 may be utilized as a exhaust line for the evacuation of gas during the injection of liquid metal, as further discussed below.

A second injector assembly 78 is preferably located above the mold halves 50, but may alternatively be otherwise positioned about the machine 70. The second injector assembly 78 includes a barrel 114 surrounded by an appropriate number of heaters 116 that operate to melt the metal received from a feed hopper 118 operating as a source of the metal for the second injector assembly 78.

The barrel 114 is mounted via a support 120 to a slide frame 122. A stepper motor or other actuator (not shown) is included within the second injector assembly 78, located within the slide frame 122, so as to facilitate movement of the barrel 114 from a retracted position (illustrated in FIG. 7) to an engaged position. In the engaged position, a nozzle 124 of the barrel 114 engages the mold halves 50 to facilitate the introduction of liquid metal into the gas pocket 58 previously created in the plastic resin 56 discharged into the cavity 54.

The second injector assembly 78 includes various common components to facilitate the melting advancement of metal through the barrel 114. One such component may be a reciprocating screw and its associated components. While the metal may be melted within the barrel 114 itself, liquid metal or metallic alloy may be introduced into the barrel 114 via the feed hopper 118 previously mentioned.

Control of the second injector assembly 78, at least with respect to the heating of the metal is achieved via a conventional thermal control unit 126, which provides signals to the second injector assembly 78 via line 128. The thermal control unit 126 may additionally control the advancement and retraction of the barrel 114 as mentioned previously.

The thermal control unit 126 itself is controlled by a system controller 130. Preferably, the system controller 130 is a stand alone microprocessor based unit having 1/O features. The system controller 130 coordinates and controls overall operation of the machine 170 and is accordingly coupled via lines 132, 134, 136, 138 and 140 respectively to the thermal control unit 126, the first injector assembly 74, gas injection assembly 76 (via both lines 136 and 138) and the second injector assembly 78.

As will be appreciated by one skilled in the art, individual components of the machine 70 can take many forms and be located in many alternate locations. Additionally, the molded part can have a variety of external shapes and be internally provided with a reinforcement of a variety of shapes, all being done without departing from the proper scope and fair meaning of the present invention as described and illustrated above and as defined by the claims appended hereto.

1. A method of molding a structurally enhanced plastic part, said method comprising the steps of:
providing a mold having a cavity defining the shape of the part to be molded;
injecting plastic material into the mold to at least partially fill the cavity of the mold;
forming a pocket within the plastic material;
injecting metal into the pocket formed within the plastic material;
solidifying the plastic material into a molded part; and
removing the molded part from the mold.

2. The method of claim 1 wherein said step of injecting plastic material substantially fills the cavity of the mold.

3. The method of claim 1 wherein said step of injecting plastic material completely fills the cavity of the mold.

4. The method of claim 1 wherein said step of forming the pocket includes the step of injecting a gas into the previously injected plastic material.

5. The method of claim 1 wherein the step of forming the pocket in the plastic materials includes the step of forming a gas pocket in the plastic material.

6. The method of claim 1 wherein the step of injecting metal includes the step of injecting at least partially liquid metal.

7. The method of claim 4 wherein said step of injecting the gas occurs before said step of injecting metal.

8. The method of claim 7 wherein said step of injecting the gas occurs at least partially before said step of injecting metal.

9. The method of claim 7 wherein said step of injecting the gas occurs completely before the step of injecting metal.

10. The method of claim 1 further comprising the step of completely encapsulating the metal within the plastic material.

11. The method of claim 1 further comprising the step of leaving a portion of the metal exposed in the plastic material.

12. A plastic part comprising:
a body of predetermined external shape, said body being formed of an injection molded plastic material;
a reinforcement located within said body, said reinforcement being formed of a metal molded in place within said body.

13. The plastic part of claim 12 wherein said reinforcement is completely encapsulated within said body.

14. The plastic part of claim 12 wherein at least a portion of said reinforcement is exposed in said body.

15. The plastic part of claim 12 wherein said reinforcement is a relatively thin walled section.

16. The plastic part of claim 12 wherein said reinforcement is a structural reinforcement.

17. The plastic part of claim 12 wherein said reinforcement is a heat dissipation member.

18. The plastic part of claim 12 wherein said reinforcement is an electrical contact.

19. The plastic part of claim 18 wherein said electrical contact is a ground.

20. An apparatus for molding plastic parts containing a metal member therein, said apparatus comprising:
a mold having surfaces defining a cavity of predetermined shape;
a first injector coupled to said mold, said first injection including a source of plastic resin material, a heater for at least partially melting the plastic resin and a ram moveably positioned within said first injector and adapted to forceably discharge the at least partially melted plastic resin from said first injector into said cavity;
a second injector coupled to said mold, said second injector comprising a source of metal material, a heater for at least partially melting the metal material, a ram moveably positioned within said second injector and adapted to forceably discharge the at least partially melted metal from said second injector into said cavity; and
a controller coupled to said first and second injectors, said controller adapted to coordinate sequencing of operation of said first and second injectors such that the at least partially melted plastic resin is injected first into the cavity and the at least partially melted metal material is injected into previously injected plastic material located within said cavity.

21. The apparatus of claim 20 further comprising pressurized gas source, said gas source being coupled to said cavity.

22. The apparatus of claim 21 wherein said gas source is further coupled to said controller and said controller is further adapted to discharge gas from said gas source into previously injected plastic material located within said cavity before injecting the at least partially melted metal material thereinto.
